(19) United States
(12) Patent Application Publication
(10) Pub. No.: US 2026/0348495 A1
(43) Pub. Date: Nov. 5, 2026

(54) CONNECTING ASSEMBLY

(71) Applicant: TI Automotive Technology Center GmbH, Rastatt (DE)

(72) Inventors: Sebastian BRIXNER, Edingen-Neckarhausen (DE); Werner MERZ, Gaggenau (DE); Gerhard KOLB, St. Leon-Rot (DE); Uenal OEZBENLIKAN, Rastatt (DE)

(21) Appl. No.: 19/105,024

(22) PCT Filed: Aug. 9, 2023
(86) PCT No.: PCT/EP2023/072055

§ 371 Date: Feb. 19, 2025

(30) Foreign Application Priority Data
Aug. 19, 2022 (DE) 20 2022 104 716.2

(51) Int. Cl. F16L 19/07

(52) U.S. Cl. CPC F16L 19/07; F25B 2309/06

(57) ABSTRACT

A connecting assembly includes a conduit element having a tubular section and a thickening formed at one end, a component having at least one channel, and a connecting element. The connecting element has a recess and the conduit element is arranged in the recess such that the connecting element is fixed on the conduit element in a form-fitting and loss-proof manner by means of the thickening. The thickening forms a contact section and an abutting section connects to the channel on the side facing the conduit element. The cross-section of the abutting section widens in the direction of the conduit element, the contact section rests sealingly against the abutting section and the conduit element is connected to the channel in a flow-conducting manner. A threaded connection presses the contact section against the abutting section by means of the form-fitting connection of the connecting element and the conduit element.

### RELATED APPLICATIONS

The present disclosure claims priority to and is a national phase application of PCT Application PCT/EP 2023/072055, filed Aug. 9, 2023, which claims priority to German Patent Application 20 2022 104 716.2, filed Aug. 19, 2022, the entire contents of which are incorporated herein by reference.

### FIELD

The disclosure relates to a connecting assembly for connecting a conduit element to a component of a temperature control device.

### BACKGROUND

Such connecting assemblies are particularly required for the use in temperature control circuits in the field of electromobility. To achieve a high range for electric vehicles, for example, it is necessary to control the temperature of electrical components. The components of electric vehicles whose temperature needs to be controlled are, in particular, electrical energy storage units, but also the power electronics or connectors of fast-charging devices. An electrical energy storage device has a best possible capacity only in a very small temperature spectrum. Another essential aspect relates to the air-conditioning of a vehicle interior which is air-conditioned with a temperature control device in form of an air-conditioning system.

For this purpose, it is known to provide a temperature control circuit through which a temperature control medium flows. If the temperature control circuit is a refrigerant circuit, the temperature control medium can be a refrigerant such as CO2 or a halogenated hydrocarbon. Depending on the requirements, the temperature control medium can either be heated in a heating device or cooled in a cooling device. The temperature control medium is transported to various components of the temperature control circuit via conduits. With CO2 air-conditioning systems in particular, the pressure on the high-pressure side can be around 170 bar and around 100 bar on the low-pressure side. The bursting pressure is around 340 bar. The temperature of the temperature control medium can lie in a range between −30 °C and 100 °C

This results in the need of the conduits being permanently sealingly connected to the components even at high operating pressures.

### SUMMARY

The present disclosure provides a connecting assembly for connecting a conduit element to a component of a temperature control device, which is easy to install and has a high level of operational reliability.

The connecting assembly for connecting a conduit element to a component of a temperature control device according to the disclosure comprises a conduit element having a tubular section and a thickening formed at one end of the conduit element, a component, having at least one channel, and a connecting element, wherein the connecting element has a recess and the conduit element is arranged in the recess in such a way that the connecting element is fixed on the conduit element in a form-fitting and loss-proof manner by means of the thickening, wherein the connecting element and the component each have a thread, wherein the threads are engaged and form a threaded connection, wherein the thickening forms a contact section and wherein an abutting section connects to the channel on the side facing the conduit element, wherein the cross-section of the abutting section widens in the direction of the conduit element, wherein the contact section rests sealingly against the abutting section and wherein the conduit element is connected to the channel in a flow-conducting manner, wherein the threaded connection presses the contact section against the abutting section by means of the form-fitting connection of the connecting element and the conduit element.

By means of the recess of the connecting element, the connecting element forms a collar that protrudes inwards, i.e., towards the longitudinal axis of the connecting element, the collar being supported by the thickening on a side of the thickening facing the tubular section of the conduit element. The connecting element is thus held in a loss-proof manner along the longitudinal axis of the conduit element in the direction of the thickening. The connecting element is arranged in a rotatable manner around the conduit element. The thread of the connecting element is formed on the side of the connecting element facing away from the recess and engages with the thread of the component. By screwing the thread of the connecting element into the thread of the component, the connecting element is moved relative to the component in the direction of the component. By means of the collar of the connecting element formed by the recess, a force can be transmitted onto the thickening of the conduit element. In addition, the conduit element and the component are arranged in such a way that the contact section and abutting section come to rest against each other and the force is transmitted from the conduit element to the component. Thus, by screwing the connecting element into the component, the conduit element is pressed against the component by means of the force transmission from the connecting element to the conduit element and from the conduit element to the component, which further increases operational reliability while providing easy mountability. By means of the threaded connection, a detachable connection is formed. This results in the possibility of re-screwing, particularly in the event of maintenance.

In case of the present disclosure, thickening means an external widening of the outer contour of the conduit element. The inner contour of the conduit element is initially independent of the thickening. In particular, the inside diameter can be constant in the region of the thickening. It is also conceivable that the inner contour correlates with the outer contour in the region of the thickening. Such a contour with an outer thickening can be formed by upsetting, for example.

The connecting element can be formed of metallic material. Preferably, the connecting element is formed of steel or aluminum. As a result, the connecting element has the mechanical properties required for the use in the area of temperature control devices, for example high strength. This can further increase operational reliability.

The thickening of the conduit element can have a curved outer contour facing away from a longitudinal axis of the conduit element. The outer contour of the thickening can be essentially convex in relation to the longitudinal axis of the conduit element. The connecting element is supported on the side of the thickening facing the tubular section of the conduit element. The side of the thickening facing away from the tubular section of the conduit element comes to rest partially against the component and forms a sealing connection with the component. In particular, the outer contour of the thickening can be formed spherical.

The radius of the sphere is preferably in the range from 1 mm to 8 mm. In this context, spherical can be understood as spherical dome-shaped or spherical disk-shaped. An essentially spherical embodiment of the outer contour of the thickening can compensate for an angular offset of the conduit element in relation to the longitudinal axis of the channel. In particular, an angular offset in a range of up to 3° can be compensated, which increases the tolerance during assembly and improves mountability.

It is also conceivable that the outer contour of the thickening is formed by other geometric shapes that are suitable for supporting the connecting element and forming a sealing connection. For example, the cross-section-enlarging transition from the tubular section to the thickening can be defined by a further radius. In doing so, the radius of the transition is preferably in the range from 0.2 mm to 5 mm.

The abutting section can form a conical cross-section. Due to the conical cross-section, a moderate lateral offset of the conduit element to the component can be compensated for during assembly. With a moderate lateral offset during assembly, the contact section of the conduit element touches the abutting section of the component laterally offset to the desired central position with the longitudinal axes of the conduit element and channel being essentially parallel. In the desired installation position, the longitudinal axes of the conduit element and channel essentially coincide, and the contact section rests completely against the abutting section. With a moderate lateral offset, the contact section only rests against the abutting section in sections or punctual. Due to the conical shape of the abutting section, when force is applied from the contact section to the abutting section arranged at an angle to it, the conduit element moves until the longitudinal axes of the conduit element and the channel coincide. The conduit element is therefore self-centering during assembly, which further improves the mountability.

The conical cross-section can form a conical surface, wherein the conical surface has an opening angle in the range from 10° to 70° to the longitudinal axis of the channel. The opening angle is particularly preferred in the range from 20° to 50°. This achieves good self-centering of the conduit element with a compact embodiment of the component at the same time. This enables simplified assembly processes.

It is also conceivable that the abutting section has a different shape with a widening cross-section instead of a conical cross-section. The widening of the cross-section is formed in the direction of the conduit element. In particular, the abutting section can form a spherical or parabolic cross-section.

The force introduced into the conduit element during assembly essentially acts along the longitudinal axis of the conduit element. Due to the conical cross-section of the abutting section, force components act perpendicularly and transversely to the conical surface. As a result, improved force transmission can be achieved for the annular-formed contact section, which results in a high level of tightness and thus improved operational reliability.

The conduit element can be formed of a first material with a first hardness and the abutting section of the component can be formed of a second material with a second hardness, wherein the first hardness and the second hardness are different. Due to the different hardnesses, the component with the lower hardness is deformed when the contact section is pressed against the abutting section. The deformation is a plastic deformation, so that the component with the lower hardness retains the deformation permanently. This deformation ensures that the component with the lower hardness is molded onto the other component in such a way that surface pressure is created and both components come to rest against each other in a sealing manner. The seal therefore does not require a costly separate gasket, which also further improves the mountability. Preferably, the first hardness is less than the second hardness, so that the contact section of the conduit element deforms to form a seal during assembly while the abutting section remains dimensionally stable. Preferably, the first material comprises a first aluminum alloy and the second material comprises a second aluminum alloy, wherein the hardnesses of the two aluminum alloys differ.

Depending on the application, it may be advantageous to provide the abutting section and/or the contact section with a coating. The coating can have a material with a lower hardness compared to the material of the abutting section or contact section. In particular, the coating may contain copper. The coating can further improve the seal.

The conduit element can have a wall thickness in the range from 0.7 mm to 3 mm. In particular, the wall thickness can be 1.5 mm. Due to such a wall thickness, the conduit element forms a mechanically stable thickening that is well suited to form a sealing connection. At the same time, desired deformations of the material can be achieved with moderate force. This ensures a sealing connection and easy mountability at the same time.

The conduit element can be formed rotationally symmetrical, wherein the thickening has a first outside diameter, wherein the first outside diameter corresponds to the largest outside diameter of the thickening, wherein the tubular section has a second outside diameter, wherein the ratio of the first outside diameter to the second outside diameter is in a range from 1.2 to 1.4. The outside diameters are each measured perpendicular to the longitudinal axis of the conduit element. The ratio of the outside diameters to each other creates a sufficiently large contact surface for the connecting element on the thickening in order to allow for the applied forces from the connecting element to the conduit element to be transmitted. Good force transmission is advantageous in order to press the contact section against the abutting section. At the same time, a compact embodiment of the connecting element is enabled. This achieves a good ratio between the power transmission and the compact embodiment, which improves both operational reliability and mountability. In particular, the first outside diameter can be in the range from 11 mm to 16 mm and the second outside diameter in the range from 8 mm to 13 mm.

The thread of the connecting element can be formed as an internal thread and the thread of the component as an external thread. This means that the connecting element is formed as a union nut. The union nut forms a sleeve-shaped section that covers the thickening during assembly and protects it from external influences.

The thread of the connecting element can be formed as an external thread and the thread of the component as an internal thread. This means that the connecting element is formed as a union screw. The connecting element can be screwed into the component, so that only parts of the connecting element protrude from the component. This enables a space-saving assembly.

The threaded connection can have a coating. The coating can have friction-optimizing properties, so that screwing the connecting element into the component is simplified, thus the mountability is increased. It is also conceivable that the coating is formed as an anti-corrosion coating. Preferably, the coating has friction-optimizing and corrosion-protecting properties.

The disclosure also relates to a temperature control circuit, comprising at least one connecting assembly according to the disclosure for connecting a conduit element to a component of a temperature control device. The connecting assembly has a high level of operational reliability for temperature control circuits.

The temperature control circuit can comprise a temperature control medium, wherein the temperature control medium flows through the temperature control circuit. Depending on the requirements, the temperature control medium can either be heated in a heating device or cooled in a cooling device. The temperature control medium can be transported to various components of the temperature control circuit via conduits. A refrigerant such as R744 (CO2) or a halogenated hydrocarbon can be used as the temperature control medium.

The disclosure also relates to an air-conditioning circuit with a high-pressure side and a low-pressure side, wherein at least one of the sides has a connecting assembly according to the disclosure for connecting a conduit element to a component of a temperature control device. The ratio of the first outside diameter to the second outside diameter is in the range from 1.3 to 1.4 for a connecting assembly on the high-pressure side. In particular, the first outside diameter can be in the range from 11 mm to 13 mm and the second outside diameter in the range from 8 mm to 10 mm. In a connecting assembly on the low-pressure side, the ratio of the first outside diameter to the second outside diameter is in the range from 1.2 to 1.3. In particular, the first outside diameter can be in the range from 14 mm to 16 mm and the second outside diameter in the range from 11 mm to 13 mm. As a result, the ratio between the power transmission and the compact embodiment is formed for the corresponding pressure ratios on the high-pressure side and low-pressure side.

### BRIEF DESCRIPTION OF THE DRAWINGS

One embodiment of the connecting assembly according to the disclosure is explained in more detail below with reference to the figures. These show, each schematically:

FIG. 1 a connecting assembly with a union screw;

FIG. 2 the connecting assembly in a disassembled state;

FIG. 3 a connecting assembly with a union nut;

FIG. 4 a conduit element of the connecting assemblies shown in FIGS. 1 to 3;

FIG. 5 an alternative embodiment of a conduit element for one of the connecting assemblies shown in FIGS. 1 to 3.

### DETAILED DESCRIPTION

The figures show a connecting assembly 1 for connecting a conduit element 2 to a component 3 of a temperature control device in a sectional view. The connecting assembly 1 comprises a conduit element 2 with a tubular section 4 and a thickening 5 formed at one end of the conduit element 2, a component 3, having at least one channel 6, and a connecting element 7. The conduit element 2 is connected to the channel 6 in a flow-conducting manner.

The connecting element 7 has a recess 8. The conduit element 2 is arranged in the recess 8 and is supported against the thickening 5, so that the connecting element 7 is fixed on the conduit element 2 in a form-fitting and loss-proof manner by means of the thickening 5. The connecting element 7 is arranged in a rotatable manner around the conduit element 2.

An abutting section 13 connects to the channel 6 of the component 3 on the side facing the conduit element 2. The cross-section of the abutting section 13 widens in the direction of the conduit element 2. The thickening 5 forms a contact section 12. The contact section 12 rests sealingly against the abutting section 13.

The connecting element 7 and the component 3 each have a thread 9, 10. The thread of the connecting element 9 is formed on the side of the connecting element 7 facing away from the recess 8 and engages with the thread of the component 9. The threads 9, 10 form a threaded connection 11. The threaded connection 11 has a coating. The coating has friction-optimizing and corrosion-protecting properties.

By screwing the thread of the connecting element 9 into or onto the thread of the component 10, the connecting element 7 moves relative to the component 3 in the direction of the component 3. By arranging the conduit element 2 in the recess 8 of the connecting element 7, a force can be transmitted onto the thickening 5 of the conduit element 2. In addition, the conduit element 2 and the component 3 are arranged in such a way that the contact section 12 and the abutting section 13 come to rest against each other and the force can be transmitted from the conduit element 2 to the component 3. Thus, by screwing the connecting element 7 into or onto the component 3, the conduit element 2 is pressed against the component 3.

The thickening 5 of the conduit element 2 has a curved outer contour 15 facing away from a longitudinal axis of the conduit element 14. The outer contour 15 of the thickening 5 is essentially convex in relation to the longitudinal axis of the conduit element 14. The connecting element 7 is supported on the side of the thickening 5 facing the tubular section 4 of the conduit element 2. The side of the thickening 5 facing away from the tubular section 4 of the conduit element 2 comes to rest partially against the component 3 and forms a sealing connection. The outer contour 15 of the thickening 5 is essentially formed spherical. The radius of the sphere is 6 mm. The cross-section-enlarging transition from the tubular section 4 to the thickening 5 is defined by a further radius. The radius of the transition is 1 mm.

The abutting section 13 forms a conical cross-section, which means that a moderate lateral offset of the conduit element 2 to the component 3 can be compensated for during assembly. The longitudinal axis of the conduit element 14 and the longitudinal axis of the channel 17 coincide and the contact section 12 rests completely on the abutting section 13. The conical cross-section forms a conical surface 16, wherein the conical surface 16 has an opening angle of 35° to the longitudinal axis of the channel 17.

The conduit element 2 is formed of a first material with a first hardness and the abutting section 13 of the component 3 is formed of a second material with a second hardness. The first hardness is less than the second hardness, so that the contact section 12 of the conduit element 2 deforms to form a seal during assembly while the abutting section 13 remains dimensionally stable. The first material has a first aluminum alloy and the second material has a second aluminum alloy.

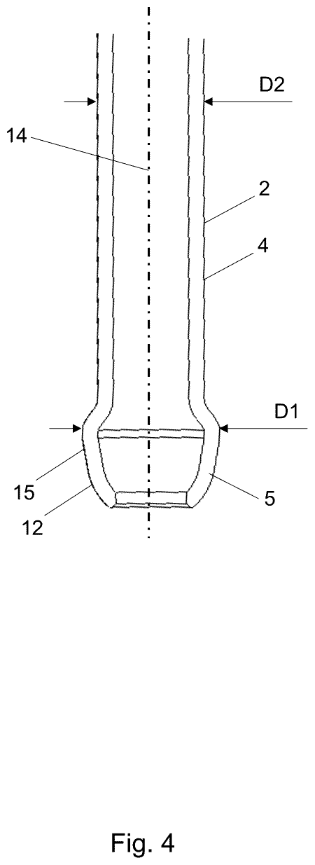

The conduit element 2 is formed rotationally symmetrical and has a wall thickness of 2 mm. The thickening 5 has a first outside diameter D1 (depicted in FIG. 4), wherein the first outside diameter D1 corresponds to the largest outside diameter of the thickening 5. The tubular section 4 has a second outside diameter D2 (depicted in FIG. 4). The outside diameters D1, D2 are each measured perpendicular to the longitudinal axis of the conduit element 14. The ratio of the first outside diameter D1 to the second outside diameter D2 is 1.3. The first outside diameter D1 is 13 mm and the second outside diameter D2 is 10 mm.

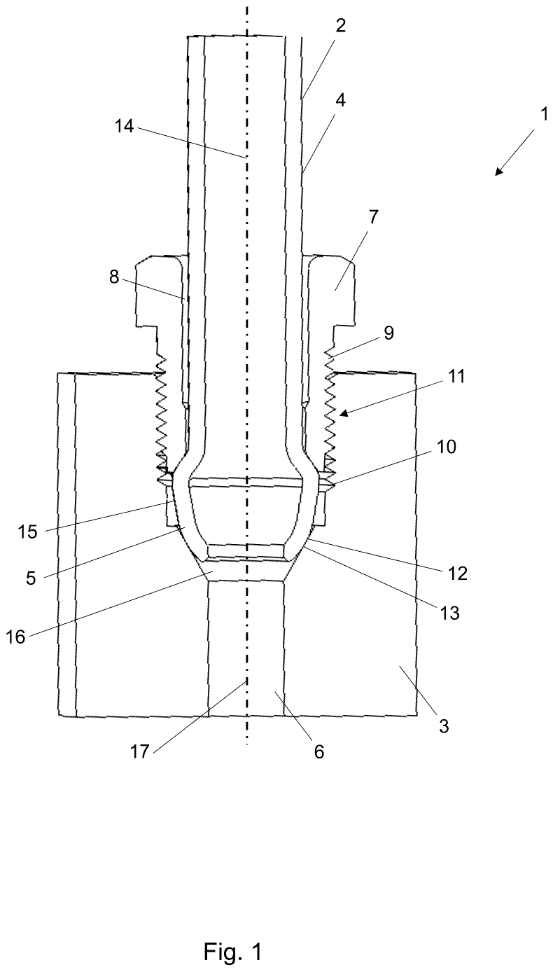

FIG. 1 shows an embodiment of the connecting assembly 1 in a sectional view, wherein the thread of the connecting element 9 is formed as an external thread and the thread of the component 10 is formed as an internal thread. The connecting element 7 is formed as a union screw and is screwed into the component 3.

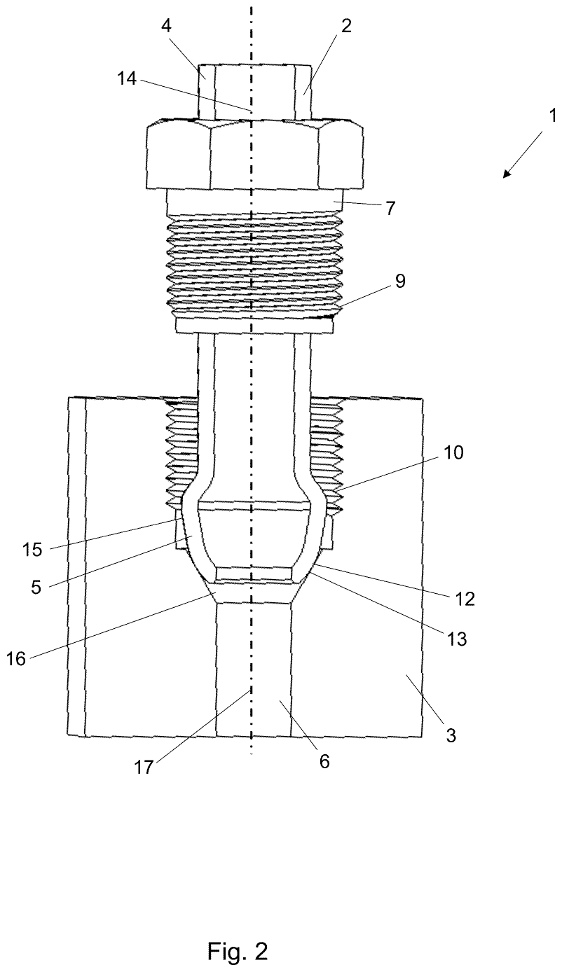

FIG. 2 shows the connecting assembly 1 for connecting a conduit element 2 to a component 3 of a temperature control device according to FIG. 1 in a sectional view, wherein the connecting element 7 is not depicted in section. In addition, the connecting element 7 is depicted in a state before assembly. The connecting element 7 is spaced from the thickening 5 along the longitudinal axis of the conduit element 14 in a direction facing away from the component 3 along the tubular section 4 of the conduit element 2. By screwing the thread of the connecting element 9 into the thread of the component 10, the contact section 12 can be pressed against the abutting section 13 in order to produce a deformation of the contact section 12 and thus a sealed connection, as shown in FIG. 1.

The connecting element 7 has a device for engaging a tool at its end facing away from the component 3. The tool engagement is formed as an external hexagon.

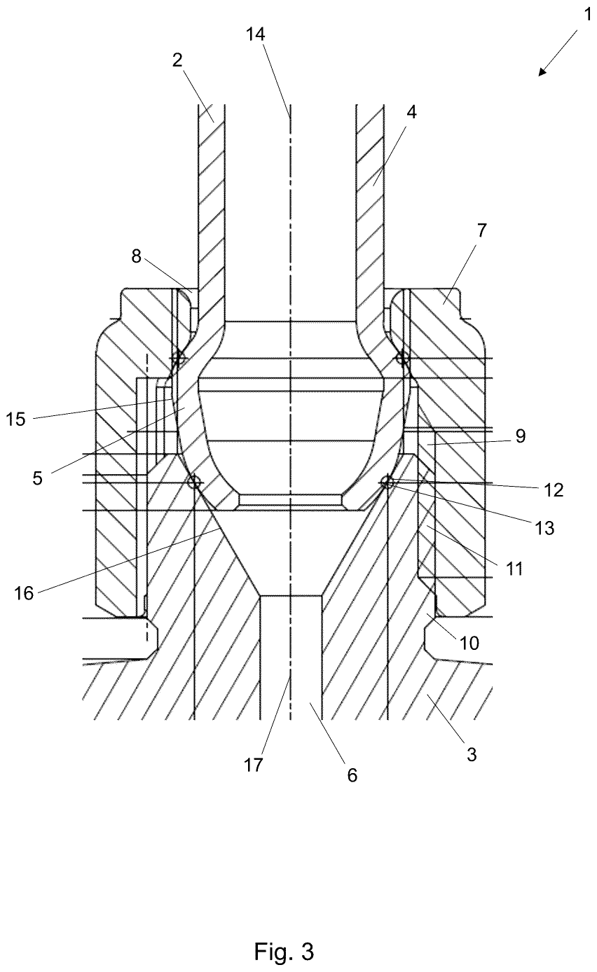

FIG. 3 shows a further embodiment of the connecting assembly 1 in a sectional view. In this embodiment of the connecting assembly 1, the thread of the connecting element 9 is formed as an internal thread and the thread of the component 10 is formed as an external thread. The connecting element 7 is formed as a union nut and is screwed onto the component 3.

FIG. 4 shows in detail the conduit element 2 of the connecting assembly 1 according to FIGS. 1 to 3 in a sectional view. Accordingly, FIG. 4 shows the conduit element 2 without the component 3 and the connecting element 7. In FIG. 4, the outside diameters D1 and D2 can be seen particularly well.

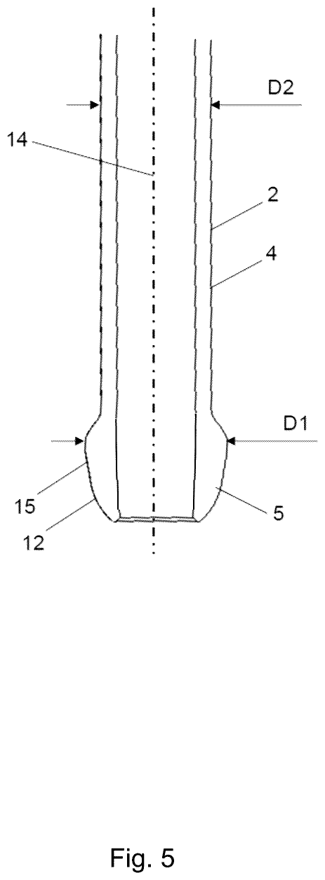

FIG. 5 shows in detail an alternative embodiment of the conduit element 2 of the connecting assembly 1 according to FIGS. 1 to 3 in a sectional view. In this alternative embodiment, the inner diameter of the conduit element 2 is constant and the thickening 5 is only formed on the outside of the conduit element 2. The inner diameter is constant, particularly in the region of the thickening 5.

1. A connecting assembly for connecting a conduit element to a component of a temperature control device, comprising a conduit element having a tubular section and a thickening formed at one end of the conduit element, a component, having at least one channel, and a connecting element, wherein the connecting element has a recess and the conduit element is arranged in the recess in such a way that the connecting element is fixed on the conduit element in a form-fitting and loss-proof manner by means of the thickening, wherein the connecting element and the component each have a thread, wherein the threads are engaged and form a threaded connection wherein the thickening forms a contact section and wherein an abutting section connects to the channel on the side facing the conduit element, wherein the cross-section of the abutting section widens in the direction of the conduit element, wherein the contact section rests sealingly against the abutting section and wherein the conduit element is connected to the channel in a flow-conducting manner, wherein the threaded connection presses the contact section against the abutting section by means of the form-fitting connection of the connecting element and the conduit element.

2. The connecting assembly for connecting a conduit element to a component of a temperature control device according to claim 1, wherein the thickening of the conduit element has an outer contour which is curved away from a longitudinal axis of the conduit element.

3. The connecting assembly for connecting a conduit element to a component of a temperature control device according to claim 1, wherein the abutting section forms a conical cross-section.

4. The connecting assembly for connecting a conduit element to a component of a temperature control device according to claim 3, wherein the conical cross-section forms a conical surface, wherein the conical surface has an opening angle in a range from 10° to 70° to the longitudinal axis of the channel.

5. The connecting assembly for connecting a conduit element to a component of a temperature control device according to claim 1, wherein the abutting section forms a spherical or parabolic cross-section.

6. The connecting assembly for connecting a conduit element to a component of a temperature control device according to claim 1, wherein the conduit element is formed of a first material with a first hardness and the abutting section of the component is formed of a second material with a second hardness, wherein the first hardness and the second hardness are different.

7. The connecting assembly for connecting a conduit element to a component of a temperature control device according to any of claim 1, wherein the conduit element has a wall thickness in the range from 0.7 mm to 3 mm.

8. The connecting assembly for connecting a conduit element to a component of a temperature control device according to claim 1, wherein the conduit element is formed rotationally symmetrical, wherein the thickening has a first outside diameter, wherein the first outside diameter corresponds to the largest outside diameter of the thickening, wherein the tubular section has a second outside diameter, wherein the ratio of the first outside diameter to the second outside diameter lies in a range from 1.2 to 1.4.

9. The connecting assembly for connecting a conduit element to a component of a temperature control device according to claim 1, wherein the thread of the connecting element is formed as an internal thread and the thread of the component is formed as an external thread.

10. The connecting assembly for connecting a conduit element to a component of a temperature control device according to claim 1, wherein the thread of the connecting element is formed as an external thread and the thread of the component is formed as an internal thread.

11. The connecting assembly for connecting a conduit element to a component of a temperature control device according to claim 1, wherein the threaded connection has a coating.

12. The connecting assembly for connecting a conduit element to a component of a temperature control device according to claim 1, wherein the connecting element is formed of metallic material.

13. A temperature control circuit, comprising at least one connecting assembly for connecting a conduit element to a component of a temperature control device configured according to claim 1.

14. The temperature control circuit according to claim 12, wherein the temperature control circuit comprises a temperature control medium, wherein the temperature control medium comprises CO₂ or halogenated hydrocarbon.

15. An air-conditioning circuit having a high-pressure side and a low-pressure side, wherein at least one of the sides has a connecting assembly for connecting a conduit element to a component of a temperature control device configured according to claim 1.
